(19) United States
(12) Patent Application Publication
(10) Pub. No.: US 2008/0010208 A1
(43) Pub. Date: Jan. 10, 2008

(54) METHOD AND APPARATUS FOR COMMUNICATION BY A SECONDARY USER OF SPECTRUM

(75) Inventor: Edgar H. Callaway, Boca Raton, FL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/456,003

(22) Filed: Jul. 6, 2006

(51) Int. Cl. G06Q 99/00

(52) U.S. Cl. 705/57

(57) ABSTRACT

A method and apparatus is provided for allowing communication of a secondary communication device (105) over non-licensed spectrum. During operation a replica transmission (114) will be periodically transmitted by a base station (111) within the secondary communication system (121). This test signal is used to exercise the beacon detection apparatus (305) of transceivers utilizing the secondary communication system. If the detection fails, transmission by the transceiver is prohibited.

### FIELD OF THE INVENTION

The present invention relates generally to wireless communications, and in particular, to a method and apparatus for communication by a secondary user of spectrum.

### BACKGROUND OF THE INVENTION

In a cognitive radio system of the type considered for use by IEEE 802.22, a cognitive secondary radio system will utilize spectrum assigned to a primary system using an opportunistic approach. With this approach, the secondary radio system will share the spectrum with primary incumbents as well as those operating under authorization on a secondary basis. Under these conditions, it is imperative that any user in the cognitive radio system not interfere with primary users. In some situations the Federal Communications Commission (FCC) of the United States has proposed the use of a control signal (or beacon) to signal the presence of primary users, and thereby identify channels that are not available for secondary operation. If a signal from the primary user or beacon is present above a predetermined signal level, secondary devices are prohibited from transmitting within the frequency band utilized by the primary user.

A weakness of above technique is that a hardware or software failure of the receiver used to detect the presence of the beacon or primary user can result in the non-detection of the beacon or primary user. The secondary user may then inadvertently transmit in the spectrum of the primary user, thereby causing interference to the primary user. To avoid this, a need exists for a method and apparatus for allowing communication over secondary spectrum that avoids interfering with the primary user when a software or hardware failure prevents detection of the primary user.

### BRIEF DESCRIPTION OF THE DRAWINGS

FIG. 1 is a block diagram of a video distribution system.

FIG. 2 is a block diagram of a base station of FIG. 1.

FIG. 3 is a block diagram of a transceiver of FIG. 1.

FIG. 4 is a flow chart showing operation of the base station of FIG. 2.

FIG. 5 is a flow chart showing operation of the transceiver of FIG. 3.

FIG. 6 is a flow chart showing operation of the transceiver of FIG. 3.

### DETAILED DESCRIPTION OF THE DRAWINGS

To address the above-mentioned need a method and apparatus is provided for allowing communication of a secondary communication device over spectrum allocated to a primary user. During operation a replica portion of a signal transmitted by the primary user will be periodically transmitted by a device within the secondary communication system. This test signal is used to exercise the primary user detection apparatus of transceivers utilizing the secondary communication system. Transceivers will report on the reception of the replica signal. If the detection fails, transmission by the transceiver is prohibited.

The present invention encompasses a method comprising the steps of creating a replicated signal and transmitting the replicated signal to a secondary user at known time periods, causing the secondary user to either prevent or allow the secondary user to transmit within the frequency band based on whether or not the replicated signal was received by the secondary user. The replicated signal is a copy of at least a portion of a signal that is transmitted by a primary user.

The present invention additionally encompasses a method for allowing or preventing communication within a communication system. The method comprises the steps of creating a replicated signal that is transmitted by a primary user within a frequency band, transmitting the replicated signal to a secondary user operating within the frequency band, and receiving an indication from the secondary user as to whether or not the replicated signal was received by the secondary user. The secondary user us allowed to transmit within the frequency band based on whether or not the replicated signal was received by the secondary user.

The present invention additionally encompasses a method comprising the steps of determining if a replicated signal was received from a secondary user, determining if a transmission from a primary user was received, and allowing or denying transmission for a secondary user based on whether or not the replicated signal was received, and whether or not the transmission from the primary user was received.

The present invention additionally encompasses an apparatus comprising logic circuitry creating a replicated signal, wherein the replicated signal is a copy of at least a portion of a signal that is transmitted by a primary user. The apparatus additionally comprises a transmitter transmitting the replicated signal to a secondary user at known time periods, causing the secondary user to either prevent or allow the secondary user to transmit within the frequency band based on whether or not the replicated signal was received by the secondary user.

The present invention additionally encompasses an apparatus comprising logic circuitry determining if a replicated signal was received from a secondary user and determining if a transmission from a primary user was received, the logic circuitry allowing or denying transmission for a secondary user based on whether or not the replicated signal was received, and whether or not the transmission from the primary user was received.

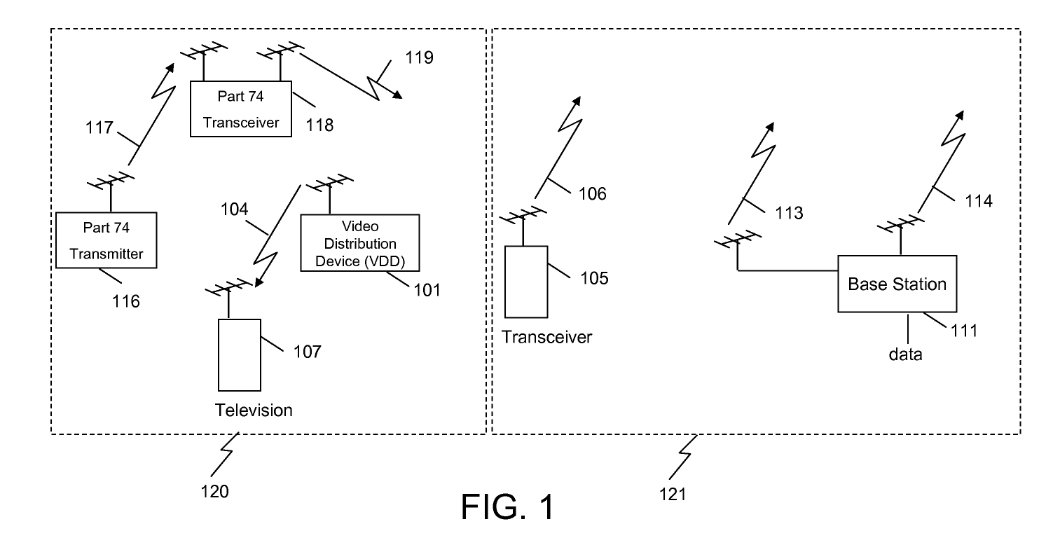

Turning now to the drawings, wherein like numerals designate like components, FIG. 1 is a block diagram of primary communication system 120 and secondary communication system 121. For illustration purposes, communication system 120 comprises a video distribution system, however, one of ordinary skill in the art will recognize that communication system 120 may take other forms, such as, but not limited to, a cellular communication system, a public-safety network, a radar system, a wireless local area network (WLAN), . . . , etc. Communication system 121 comprises, for example, a modified wireless radio access network (WRAN) as defined by the IEEE 802.22 communications system standard; however, one of ordinary skill in the art will recognize that communication system 121 may take other forms, such as, but not limited to, a WLAN, a wireless personal area network (WPAN), a public-safety network, . . . , etc.

In this illustration, it is assumed that devices within communication system 120 are authorized to transmit on a particular frequency as a primary user, and that users of communication system 121 operate under authorization on a secondary basis. Under these conditions, it is imperative that users of communication system 121 not interfere with the users of communication system 120.

As shown, communication system 120 comprises video distribution device (VDD) 101 that conforms to the Advanced Television Standards Committee (ATSC) standards and to the FCC rules concerning digital televisions. VDD 101 (acting as a transmitter) communicates with television 107 using an over-the-air ATSC-conforming transmission 104 as a composite multiplex on a broadcast television channel. Communication system 120 may also comprise transmitter 116 and transceiver 118, for example, a wireless microphone system compliant with FCC Part 74 regulations and operating on a broadcast television channel. In this example, in addition to receiving signal 117 from transmitter 116, transceiver 118 also transmits a beacon 119, advertising the presence of the communication system 120 to communication system 121.

Communication system 121 comprises base station 111 transmitting data to transceiver 105 via over-the-air downlink transmission 113. Transmissions may also be sent from transceiver 105 to base station 111 via transceiver 105 transmitting uplink communication signal 106.

Secondary radio system 121 will utilize spectrum assigned to a primary system 120 using an opportunistic approach. With this approach, the secondary radio system will share the spectrum with primary incumbents as well as those operating under authorization on a secondary basis. Under these conditions, it is imperative that any user in the cognitive radio system 121 not interfere with primary users of communication system 120.

In order for system 121 to operate as a secondary user in the broadcast television spectrum, both base station 111 and transceiver 105 must perform the necessary steps to determine an available channel for secondary operation. Particularly, both base station 111 and transceiver 105 serve as means for performing whatever determination is required by the FCC rules to ensure that their transmissions will not interfere with the users of communication system 120. This may comprise having logic circuitry determine if transmissions will cause interference by analyzing a received signal, or accessing an external database, or determining that no transmissions exist on the primary channel. After both base station 111 and transceiver 105 have determined that their transmissions on a particular channel will not interfere with communication system 120, transmissions may begin using the spectrum licensed to communication system 120.

As discussed, a weakness of above technique is that a hardware or software failure within transceiver 105 can result in the non-detection of transmission 104 or beacon 119, leading to interference to the primary user. In order to address this need, a replica 114 of transmission 104 or beacon 119 (or alternatively, a portion of transmission 104 or beacon 119) is transmitted by cognitive radio system 121 and a determination is made as to whether or not transceiver 105 detects replica transmission 114. In a first embodiment, a burst of the protected digital television (DTV) pilot tone 103 is periodically inserted in a packet header. This test signal 114 is used to exercise the primary signal detection apparatus of transceiver 105. Transceiver 105 will report on the reception of signal 114. If the detection fails, transmission by transceiver 105 is prohibited.

The sample signal may be sent periodically in time (e.g., every hour), after every set number of received packets (e.g., sent in every Nth packet, where N is an integer), or some combination of both (e.g., every 100 packets, but at least once per hour). Additionally, a signal quality estimate of the inserted signal can be made and stored by base station 111, so changes over time may be monitored and gradual degradation, as opposed to outright failure, of the receiver may be detected.

Thus, in accordance with the present invention, base station 111 will duplicate a signal (or beacon) that is transmitted by the primary user within a frequency band and transmit the replicated signal to a secondary user (i.e., transceiver 105) operating within the frequency band. An indication will be received from transceiver 105 as to whether or not the replicated signal was received. Base station 111 will prevent or allow transceiver 105 to transmit within the frequency band based on whether or not the replicated signal was received by transceiver 105. In a preferred embodiment of the present invention, transceiver 105 will expect reception of replica transmission 114 as part of a message of known format sent by base station 111. Transceiver 105 will prevent or allow transceiver 105 to transmit within the frequency band based on whether or not replica transmission 114 was received by transceiver 105.

It should be noted that while base station 111 is shown with a unique antenna transmitting replica transmission 114, one of ordinary skill in the art will recognize that this need not be the case since a single antenna may be utilized for transmission of both downlink transmission 113 and replica transmission 114. Similarly, while transceiver 105 is shown with a single antenna, one of ordinary skill in the art will recognize that this need not be the case since two or more antennas may be utilized for reception of downlink transmission 113 and replica transmission 114.

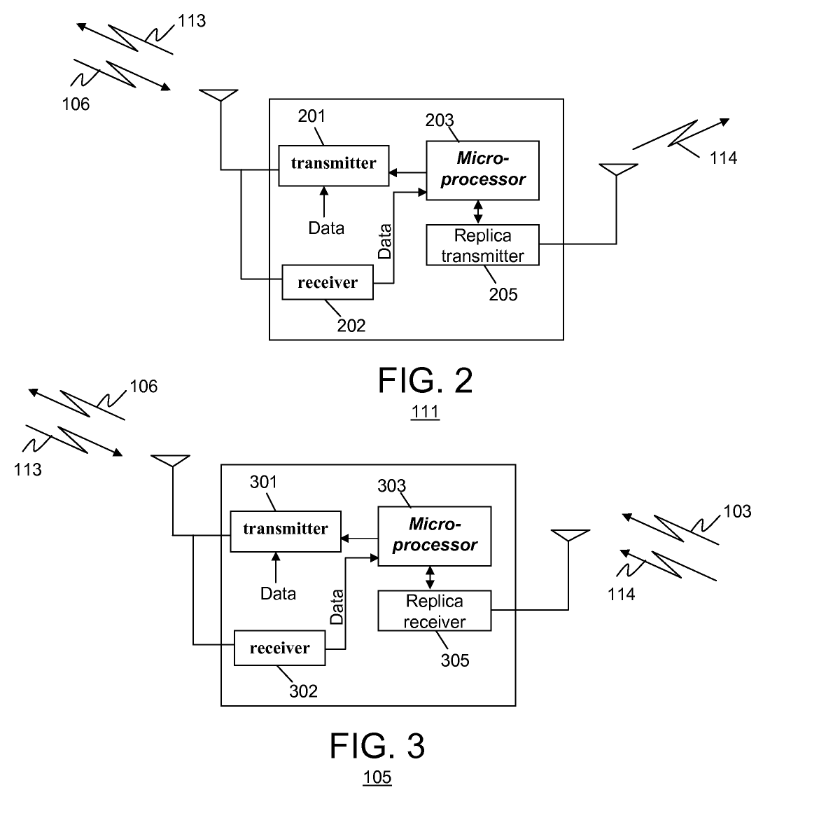

FIG. 2 is a block diagram of base station 111. As shown, base station 111 comprises logic circuitry 203 (microprocessor 203), receive circuitry 202, transmit circuitry 201, and replica transmitter 205. Logic circuitry 203 preferably comprises a microprocessor controller, such as, but not limited to a Freescale PowerPC microprocessor. In the preferred embodiment of the present invention logic circuitry 203 serves as means for controlling base station 111, and as means for analyzing message content to determine if transceiver 105 receives replica transmission 114, transmission 104, or beacon 119. Additionally receive and transmit circuitry are common circuitry known in the art for communication utilizing a well known communication protocol, and serve as means for transmitting and receiving messages. For example, receiver 202 and transmitter 201 are well known transmitters that utilize the IEEE 802.22 communication system protocol. Other possible transmitters and receivers include, but are not limited to transceivers utilizing Bluetooth, IEEE 802.11, or HyperLAN protocols. Finally, replica transmitter 205 comprises circuitry that will duplicate the signal (or beacon) that is transmitted by the primary user within a frequency band, i.e., replica transmission 114.

It should be noted, that replica transmitter 205 is not simply a “repeater”, repeating transmissions of communication system 120. Replica transmitter 205 transmits replica signals 114 at known time intervals, regardless of what is being transmitted by communication system 120. Further, in a preferred embodiment replica signals 114 comprise signals that have similar properties to those of the primary user, but may or may not have been actually sent by the primary user. For example, replica signal 114 may comprise a 1-0 digital pattern with the same modulation format and data rate as the primary user, who of course is unlikely to send such a pattern on his own.

FIG. 3 is a block diagram of transceiver 105. As shown, transceiver 105 comprises logic circuitry 303 (microprocessor 303), receive circuitry 302, transmit circuitry 301, and replica receiver 305. Logic circuitry 303 preferably comprises a microprocessor controller, such as, but not limited to a Freescale PowerPC microprocessor. In the preferred embodiment of the present invention logic circuitry 303 serves as means for controlling transceiver 105, and as means for analyzing received signals to determine if receiver 305 receives either replica transmission 114, transmission 104, or beacon 119. Additionally receive and transmit circuitry are common circuitry known in the art for communication utilizing a well known communication protocol, and serve as means for transmitting and receiving data. For example, receiver 302 and transmitter 301 are well known transmitters that utilize the IEEE 802.22 communication system protocol. Other possible transmitters and receivers include, but are not limited to transceivers utilizing Bluetooth, IEEE 802.11, or HyperLAN protocols.

As discussed above, communication system 121 can operate such that transceiver 105 reports back to base station 111 on any replica signal received, having base station 111 determine whether or not to allow transceiver 105 to communicate. Alternatively (and preferably), base station 111 may simply transmit the replica signal or beacon at a known time and transceiver 105 will prevent or allow transceiver 105 to transmit within the frequency band based on whether or not replica transmission 114 was received by transceiver 105.

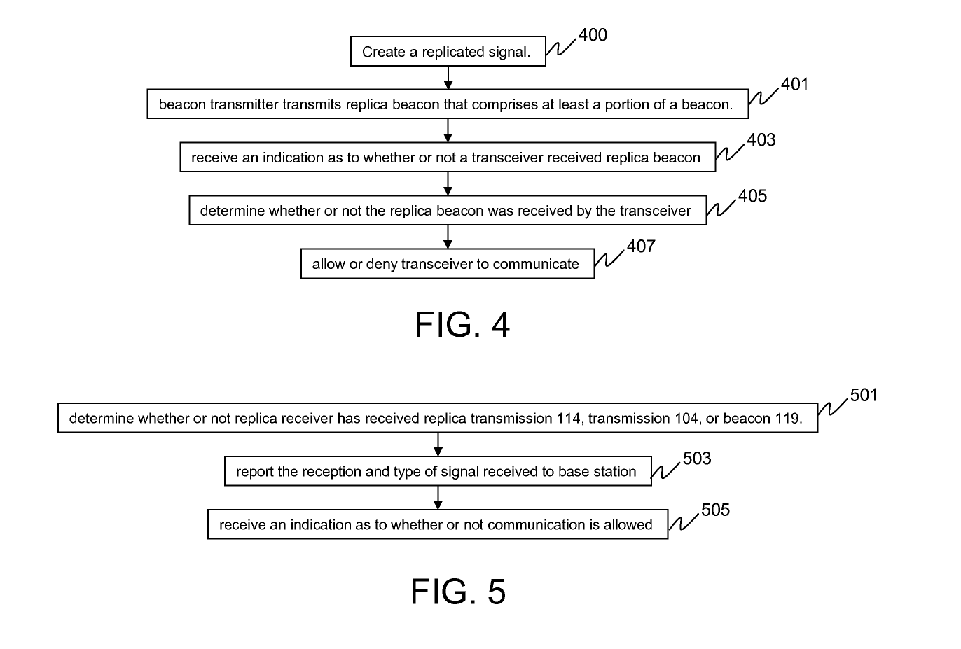

FIG. 4 is a flow chart showing operation of the base station of FIG. 2 when making the determination whether or not to allow transceiver 105 to communicate. The logic flow begins at step 400 where logic circuitry 203 creates a replicated signal, wherein the replicated signal is a copy of at least a portion of a signal that is transmitted by a primary user within a frequency band. At step 401 replica transmitter 205 transmits the replicated signal to a secondary user within the frequency band as replica transmission 114. As discussed above, replica transmission 114 may comprise a replicated transmission utilized by communication system 120, a burst of the protected digital television (DTV) pilot tone, or a beacon transmission. Additionally, the replicated signal is transmitted at known time periods. At step 403, receiver 202 receives an indication as to whether or not transceiver 105 received replica transmission 114. The indication as to whether or not transceiver 105 received replica transmission 114 may comprise a dedicated message packet, an indicative bit in a packet header, the presence or absence of a reply or acknowledgement signal, or other indications.

Continuing, at step 405 microprocessor 203 determines whether or not replica transmission 114 was received by transceiver 105 and either allows or denies transceiver 105 to communicate based on the determination (step 407). More specifically, if microprocessor 203 determines that the replica transmission 114 was not received, transceiver 105 will not be allowed to communicate via spectrum assigned to communication system 120.

As discussed above, in an alternate embodiment of the present invention transceiver 105 may report a received quality of replica transmission 114. The receive quality can be stored by base station 111, so changes over time may be monitored and gradual degradation, as opposed to outright failure, of the receiver may be detected. During this scenario, microprocessor 203 will track the receive quality of beacon signal 114 and if the quality shows degradation over time, or degradation below a threshold, transceiver 105 may be prevented from communicating via spectrum assigned to communication system 120.

FIG. 5 is a flow chart showing operation of transceiver 105 according to a first embodiment of the present invention. In the first embodiment of the present invention, transceiver 105 will report to base station 111 on any signal, beacon, or replica signal received. Base station 111 will then allow or deny transceiver 105 to communicate on a secondary basis. The logic flow begins at step 501 where microprocessor 303 accesses replica receiver 305 to determine whether or not replica receiver 305 has received replica transmission 114, transmission 104, or beacon 119. As discussed above, replica receiver 305 may receive transmission 104 transmitted via VDD 101, beacon 119 transmitted by transceiver 118, or replica transmission 114 transmitted by replica transmitter 205. Regardless which of these signals were received, microprocessor 303 reports their reception and type to base station 111 (step 503) via transmitter 301. At step 505, receiver 302 then receives an indication as to whether or not communication is allowed over spectrum assigned to communication system 120.

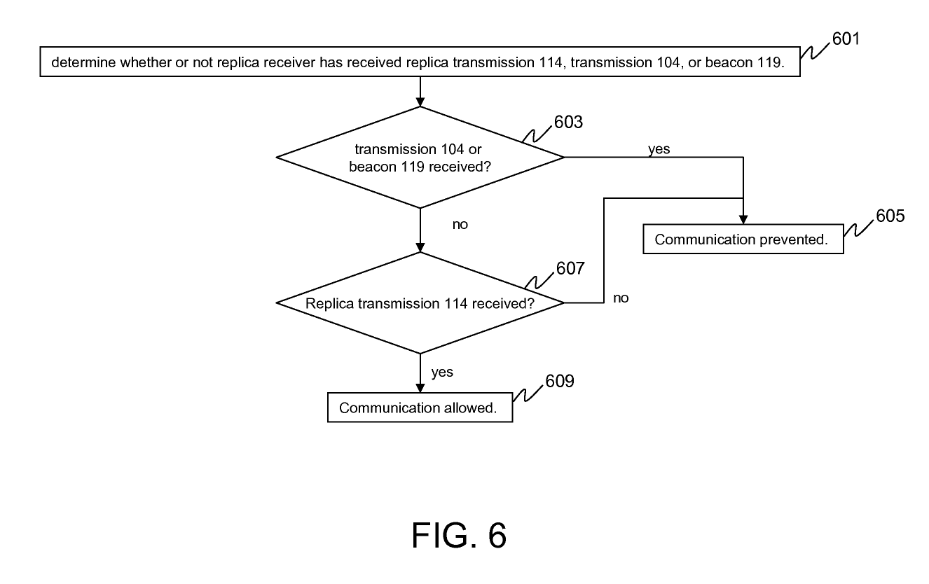

FIG. 6 is a flow chart showing operation of transceiver 105 according to a second embodiment of the present invention. In a second embodiment of the present invention, transceiver 105 will prevent itself from communicating if replica transmission 114 is not heard at the appropriate time. The logic flow begins at step 601 where microprocessor 303 accesses replica receiver 305 to determine whether or not replica receiver 305 has received replica transmission 114 at the appropriate time, transmission 104, or beacon 119. As discussed above, replica receiver 305 may receive transmission 104 transmitted via VDD 101, beacon 119 transmitted by transceiver 118, or replica transmission 114 transmitted (at an appropriate time) by replica transmitter 205. The logic flow then continues to step 603 where logic circuitry 303 determines if transmission 104 or beacon 119 was received. If so, the logic flow continues to step 605 where communication on a secondary basis is prevented by logic circuitry 303. If, at step 603 it is determined that transmission 104 or beacon 119 were not heard, the logic flow continues to step 607 where logic circuitry 303 determines if replica transmission 114 was received at the appropriate time. If, at step 607, logic circuitry 303 determines that replica transmission 114 was received, the logic flow continues to step 609, where communication on a secondary basis is allowed, otherwise the logic flow returns to step 605 where communication on a secondary basis is prevented by logic circuitry 303.

While the invention has been particularly shown and described with reference to a particular embodiment, it will be understood by those skilled in the art that various changes in form and details may be made therein without departing from the spirit and scope of the invention. For example, transceiver 105 may transmit replica transmission 114, rather than base station 111, in which case transmission from base station 111 will depend upon proper reception of replica transmission 114. As a second example, to counteract the presence of fading, the decision to inhibit transmission may be made based on a number of reception results, not just one, and may consider other factors, such as a correlation value to a pseudo-noise sequence in replica transmission 114. It is intended that such changes come within the scope of the following claims.

1. A method comprising the steps of:
creating a replicated signal, wherein the replicated signal is a copy of at least a portion of a signal that is transmitted by a primary user; and
transmitting the replicated signal to a secondary user at known time periods, causing the secondary user to either prevent or allow the secondary user to transmit within the frequency band based on whether or not the replicated signal was received by the secondary user.

2. The method of claim 1 wherein the step of transmitting the replicated signal comprises the step of transmitting a burst of a digital television (DTV) pilot tone periodically inserted in a packet header.

3. The method of claim 1 wherein the step of transmitting the replicated signal comprises the step of transmitting a burst of a digital television (DTV) pilot tone, a transmission of the primary user, or a portion of a beacon.

4. The method of claim 1 wherein the step of transmitting the replicated signal comprises the step of transmitting the replicated signal at known time periods.

5. The method of claim 1 wherein the step of transmitting the replicated signal comprises the step of transmitting a replicated signal in every Nth packet.

6. A method for allowing or preventing communication within a communication system, the method comprising the steps of:
creating a replicated signal that is transmitted by a primary user within a frequency band;
transmitting the replicated signal to a secondary user operating within the frequency band;
receiving an indication from the secondary user as to whether or not the replicated signal was received by the secondary user; and
preventing or allowing the secondary user to transmit within the frequency band based on whether or not the replicated signal was received by the secondary user.

7. The method of claim 6 wherein the step of transmitting the replicated signal comprises the step of transmitting a burst of a digital television (DTV) pilot tone periodically inserted in a packet header.

8. The method of claim 6 wherein the step of transmitting the replicated signal comprises the step of transmitting a burst of a digital television (DTV) pilot tone or a portion of a beacon.

9. The method of claim 6 wherein the step of transmitting the replicated signal comprises the step of transmitting the replicated signal at known time periods.

10. The method of claim 6 wherein the step of transmitting the replicated signal comprises the step of transmitting a replicated signal in every Nth packet.

11. A method comprising the steps of:
determining if a replicated signal was received from a secondary user;
determining if a transmission from a primary user was received; and
allowing or denying transmission for a secondary user based on whether or not the replicated signal was received, and whether or not the transmission from the primary user was received.

12. The method of claim 11 wherein transmission is allowed if the replicated signal was received.

13. The method of claim 11 wherein transmissions are not allowed if the transmission from the primary user was received.

14. The method of claim 11 further comprising the step of:
reporting whether or not the replicated signal was received and whether or not the transmission from the primary user was received to a base station.

15. An apparatus comprising:
logic circuitry creating a replicated signal, wherein the replicated signal is a copy of at least a portion of a signal that is transmitted by a primary user; and
a transmitter transmitting the replicated signal to a secondary user at known time periods, causing the secondary user to either prevent or allow the secondary user to transmit within the frequency band based on whether or not the replicated signal was received by the secondary user.

16. The apparatus of claim 15 wherein the replicated signal comprises a burst of a digital television (DTV) pilot tone.

17. The apparatus of claim 15 wherein the replicated signal comprises a burst of a digital television (DTV) pilot tone, a transmission of the primary user, or a portion of a beacon.

18. An apparatus comprising:
logic circuitry determining if a replicated signal was received from a secondary user and determining if a transmission from a primary user was received, the logic circuitry allowing or denying transmission for a secondary user based on whether or not the replicated signal was received, and whether or not the transmission from the primary user was received.

19. The apparatus of claim 18 wherein transmission is allowed if the replicated signal was received.

20. The apparatus of claim 18 wherein transmissions are not allowed if the transmission from the primary user was received.
